(19) United States
(12) Patent Application Publication
(10) Pub. No.: US 2012/0090239 A1
(43) Pub. Date: Apr. 19, 2012

(54) Revolving Door Lock

(75) Inventor: Peter Lodewijk Hondius, Edam (NL)

(73) Assignee: Royal Boon Edam Group Holding B.V., Edam (NL)

(21) Appl. No.: 13/281,709

(22) Filed: Oct. 26, 2011

Related U.S. Application Data
(63) Continuation of application No. PCT/NL2010/050242, filed on Apr. 27, 2010.

(30) Foreign Application Priority Data
Apr. 29, 2009 (NL) 2002818

(51) Int. Cl. E06B 3/38; E05F 15/04; E05D 15/02

(52) U.S. Cl. 49/27; 49/42

(57) ABSTRACT

A revolving door lock having outer walls defining in-between said walls a passageway, comprising at the extremities of the passageway a first revolving door and a second revolving door that embody an entrance and an exit of the door lock, wherein each of the first revolving door and the second revolving door is provided with shell-walls shaped as parts of a cylinder-wall and wherein the revolving doors each have door-wings that are rotatable between said shell-walls such that during rotation extremities of said door-wings are movable adjacent to said shell-walls.

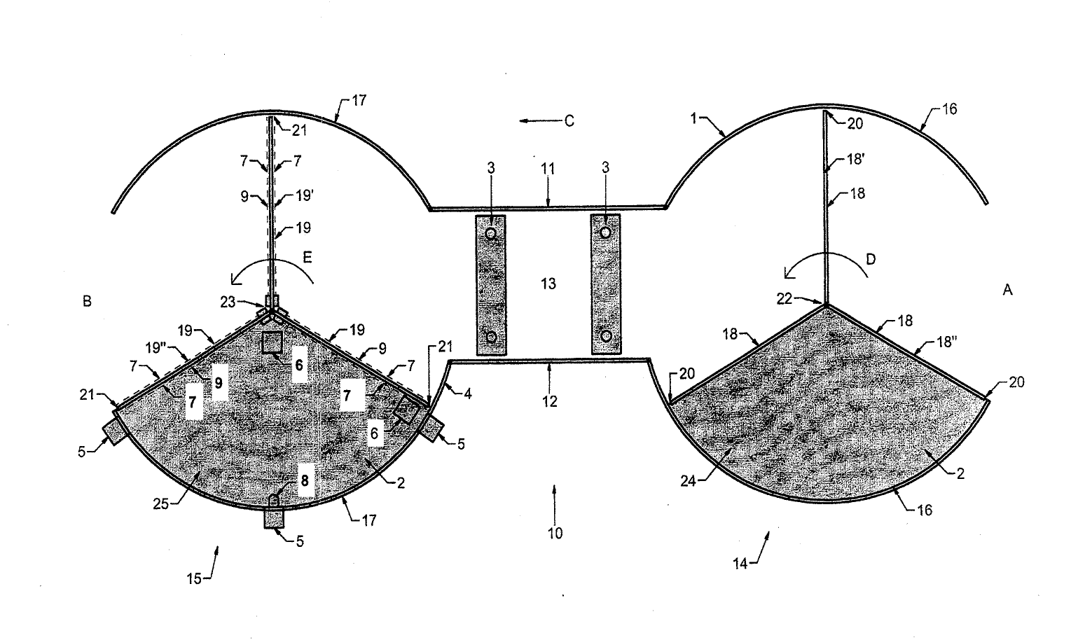

### CROSS-REFERENCE TO RELATED APPLICATIONS

This application is a continuation application of International Patent Application Serial No. PCT/NL2010/050242, entitled “Revolving Door Lock”, filed on Apr. 27, 2010, which is a continuation of Netherlands Patent Application Serial No. 2002818, entitled “Revolving Door Lock”, filed on Apr. 29, 2009, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to a revolving door lock having outer walls defining in between said walls a passageway, comprising at the extremities of the passageway a first revolving door and a second revolving door that embody an entrance and an exit of the door lock, wherein each of the first revolving door and the second revolving door is provided with shell-walls shaped as parts of a cylinder-wall and wherein the revolving doors each have door-wings that are rotatable between said shell-walls such that during rotation extremities of said door-wings are movable adjacent to said shell-walls. This provides that the passageway is always closed against draught at at least one of the revolving doors.

2. Description of Related Art

Such a revolving door lock is known from WO 1994/08121 to Nyffenegger, et al.

The known revolving door lock is provided with revolving doors each having only two door-wings. This necessitates that the respective revolving doors are operated in synchronism in order to secure that the passageway is always closed against draught at at least one of the revolving doors. The necessity to operate the revolving doors in synchronism requires that both revolving doors are linked either mechanically or electronically, which is either complicated or prone to malfunctioning.

### BRIEF SUMMARY OF THE INVENTION

It is therefore a first objective of the invention to improve the known revolving door lock such that it can be of simpler construction and less prone to malfunctioning. An additional benefit may then be that the revolving door lock can be manufactured at reduced cost.

A second objective of the invention is to provide a revolving door lock which not only is always closed against draught, but can be applied effectively to separate secure areas from non-secure areas. The secure area of the revolving door lock would then be located at the entrance, whereas the unsecure area of the revolving door lock would then be placed at the exit. In terms of this invention the meaning of secure area refers to an area in which persons are allowed that are checked, whereas the unsecure area is accessible for people who are not checked as to their authorization to enter the secure area.

A third objective is to provide a revolving door lock which allows passage from the said secure area to the unsecure area, yet prevents the passage from the unsecure area to the secure area such as explosives.

Still a further objective of the invention is to provide such a revolving door lock which protects the secure area very effectively against entry of undesirable objects such as weapons in the form of guns or knives or other undesirable objects, such as explosives.

### BRIEF DESCRIPTION OF THE SEVERAL VIEWS OF THE DRAWINGS

Hereinafter the invention will further be elucidated with reference to an exemplary embodiment of a revolving door lock in accordance with the invention and with reference to the drawing.

It is expressly noted that the above description and the following elucidation with reference to an embodiment of a revolving door lock of the invention, is not to be considered restrictive as to the scope of protection of the appended claims. The following elucidation only serves to remove any cause of possible misunderstanding as to the meaning of the words used in the claims and their intended functional interrelation.

In the drawing a single FIGURE is shown that pertains to a top-sectional view of the revolving door lock of the invention.

### DETAILED DESCRIPTION OF THE INVENTION

To realize the objectives of the invention, a revolving door lock is proposed in accordance with one or more of the appended claims.

In a first aspect of the invention the revolving door lock has the feature that each of the first revolving door and the second revolving door is provided with at least three wings, that is three or more wings, for instance four wings. Surprisingly the person skilled in the art that has been actively pursuing the improvement of the known revolving door lock according to WO 94/08121 since its emergence in the early 1990's of the previous century, has not come up with the idea to embody the first revolving door and the second revolving door with at least three wings. It is, however, particularly this feature which allows that the revolving door lock can be embodied without need to synchronize the two revolving doors that are part of the revolving door lock. The revolving door lock of the instant invention can therefore be simplified as compared to the prior art, whereby the embodiment with three wings does not have to go at the expense of a reduced capacity of the revolving door lock.

The capacity of the revolving door lock of the invention can in particular be maintained at a high level by embodying the revolving door lock of the invention with the feature that the passageway is placed off-centre with respect to an imaginary line through the axes of rotation of the door-wings so as to cause that passers-by can pass the door lock without noticeably moving sideways.

The protection against draught and also the revolving door lock's suitability to protect against a throwing in of undesirable objects from the unsecure area located at the exit, is promoted by having the shell-walls arranged such that when a wing of a revolving door is positioned perpendicular to an imaginary line through the axes of rotation of the door-wings, another wing is having its extremity positioned immediately adjacent to a shell-wall.

In order to raise the level of security that the revolving door lock can provide in diverse situations as will be further detailed hereinafter, it is preferable that the door lock comprises control means that control the rotation or interruption of rotation of at least one of the revolving doors, which control means are receivingly connected with detection means for detecting unauthorized situations.

One of the features that is beneficial to prevent a person going from an unsecure area (at the exit) to a secure area (at the entrance), which areas are obviously on respective sides of the revolving door lock of the invention, it is desirable that the passageway is provided with means for recognition of a person's movement-direction. In connection therewith it is preferred that the control means is arranged to interrupt and/or block rotation or to reverse rotation of the revolving door at the entrance when said means detects an unauthorized movement-direction.

The means for recognition of a person's movement-direction can be any suitable means but it has proven that the said means can suitably be embodied as radar-transceivers that are positioned at the extremities of the passageway between the revolving doors at the entrance and the exit. It is, however, also possible to use other types of direction sensitive sensors or to apply suitable camera systems.

It is further beneficial that the first revolving door and/or the second revolving door is equipped with means for object-detection selected from the group comprising object-sensors and a pressure-sensitive floor-part. By applying pressure-sensitive floor-parts furthermore an additional and effective means is provided to detect when a person is trying to enter the secure area from the unsecure area or when a person initially was leaving the secure area and is trying to reverse to this area.

Preferably the pressure-sensitive floor-part is provided in a predefined no-go area of the respective revolving doors, which no-go area is established in the path of passers-by going through the door-lock from the exit (the unsecure area) to the entrance (the secure area). Also in this situation it is desirable that the control means is arranged to interrupt rotation or to reverse rotation of at least the revolving door of which the pressure-sensitive floor-part registers a load.

In order to complete the protective features of the revolving door lock of the invention, it is preferred that the detection means for detecting unauthorized situations comprise one or more sensors for detecting objects in the revolving door, preferably at the exit, and that the control means is arranged to interrupt or block rotation, or reverse rotation of said revolving door upon activation of at least one of said sensors. Said objects as detected by a sensor can be brought in the revolving door by throwing in or by sticking it to a door-wing. It may further be beneficial to apply sensors that can be placed at the entrance of the revolving door lock.

It is further preferred that the revolving door lock is provided with means on the shell-walls for scraping off objects that stick to extremities of the door-wings. These means can also be embodied as sensor.

The revolving door lock is generally denoted with reference numeral 10. This revolving door lock 10 has outer walls 11, 12 defining in-between said walls 11, 12 a passageway 13 comprising at the extremities of the passageway 13 a first revolving door 14 and a second revolving door 15 that respectively embody an entrance A and an exit B of the revolving door lock 10 of the invention. The entrance A will for sake of ease be considered to be at the secure area of the revolving door lock 10 and the exit B shall for the same reason be considered to relate to the unsecure area of the revolving door lock 10 of the invention.

As the FIGURE clearly shows, both the first revolving door 14 and the second revolving door 15 are provided with shell-walls 16 and 17 respectively, that are shaped as parts of a cylinder-wall 1, 4. Further, the revolving doors 14, 15 each have door-wings 18 and 19 respectively that are rotatable between said shell-walls 16, 17. It is further clear that during rotation of said door-wings 18, 19 the said door-wings' extremities 20 and 21 respectively, move closely adjacent to said shell-walls 16, 17 thus inter alia providing an effective seal against draught during rotation of the door-wings 18, 19. This is, however, also an important aspect to allow the revolving door lock of the invention to operate as a security door. For this purpose one of the features of the revolving door lock 10 of the invention is that it is provided with means 8 on the shell-walls 16, 17 for scraping off objects that stick to extremities 20, 21 of the door-wings 18, 19. These means may also be embodied as a sensor 8 for the detection of objects in the door, as will be further explained hereinafter.

It is apparent from the FIGURE that each of the first revolving door 14 and the second revolving door 15 has three wings 18 and 19 respectively. An embodiment wherein there are four (or even more) door-wings is however also embraced within the scope of the invention.

Although the FIGURE shows the first revolving door 14 and the second revolving door 15 in a similar position, the beauty of the invention is that both revolving doors 14, 15 can be operated entirely independently from each other without synchronization and without losing the property that the revolving door lock 10 of the invention is at all times providing an effective seal against undesirable draught through the passageway 13. This is also beneficial for the security-properties of the door lock 10.

The FIGURE shows clearly that the shell-walls 16, 17 of both revolving doors, 15 are arranged such that when a wing 18′, 19′ of a revolving door 14, 15 is positioned perpendicular to an imaginary line through the axes 22, 23 around which the respective door-wings 18, 19 rotate, that another wing 18″, 19″ is having its extremity 20, 21 positioned immediately adjacent to a shell-wall 16, 17 so as to effect that the concerning revolving door 14, 15 is effectively closed against draught and against throwing in of undesirable objects.

The rotation of the door-wings 18, 19 of the respective revolving doors 14, 15 is actuated by a motor drive. The operation of the motor drive depends on a control means (not shown) that controls the rotation or—if deemed necessary—the interruption or blocking of rotation of at least one of the revolving doors 14, 15. For this purpose the control means are receivingly connected with detection means 2, 3, 5, 6, 7, 8, 9 for detecting unauthorized situations. Some examples of such detection means and the cooperation of the detection means with the control means are detailed hereinafter.

The FIGURE shows that the passageway 13 is provided with means 3 for recognition of a person's movement direction. The control means is then suitably arranged to interrupt and/or block rotation or to reverse rotation of the revolving door 14 at the entrance A when said means 3 detects an unauthorized movement direction. The means are for instance radar-transceivers 3 that as the FIGURE shows are positioned at the extremities of the passageway 13. It is however also possible to apply for this purpose camera systems or other direction sensitive sensors.

Although the passageway 13 is shown as a relatively-narrow corridor, its placement is off-centre with respect to the imaginary line through the axes 22, 23 of rotation of the door-wings 18, 19, so as to cause that persons that walk from the entrance A in the direction of arrow C to exit B can pass by the revolving door lock 10 of the invention without noticeably moving sideways.

A further example of detection means to detect unauthorized situations is the application of object-detection means such as the object-sensors 5, 6 as shown in the second revolving door 15, and/or pressure-sensitive floor-parts 2 in the first revolving door 14 and/or the second revolving door 15 respectively. As will be clear from the FIGURE a person moving through the revolving door lock 10 of the invention going from the entrance A to the exit B does not come into contact with any pressure-sensitive floor-part 2 as provided in the revolving doors 14, 15 due to the rotational direction D, E of the respective revolving doors 14, 15. If on the other hand a person would try to pass through the revolving door lock 10 of the invention going from the exit B to the entrance A, such person would in view of the rotational directions D and E of the door-wings 18, 19 enter into a no-go area at which the respective pressure-sensitive floor-parts 2 are provided. For a person moving from the exit B in a direction contrary to arrow C this no-go area is the area 25 of the revolving door 15, whereas for a person trying to revert from the passageway 13 after first having left the secure area at the entrance A, this no-go area is the area 24 of revolving door 14. Likewise as with the operation of the control means depending on the means 3 for recognition of a person's movement direction in the passageway 13, the control means is arranged to interrupt or block rotation or to reverse rotation of at least the revolving door 14, 15 of which the pressure-sensitive floor-part 2 registers a load.

Finally, the revolving door lock 10 of the invention, in particular the revolving door 15 at the exit B, is suitably provided with sensors 5, 6, 7, 8, 9 for detecting undesirable objects and the control means is arranged to interrupt rotation or reverse rotation of said revolving door 15 upon activation of at least one of said sensors 5, 6, 7, 8, 9. For sake of completeness it is remarked that although the FIGURE does not show it, such sensors may also be applied at the revolving door 14 at the entrance A of the revolving door lock 10.

As an example the sensor 5 may be employed for detecting objects being thrown in the door with the purpose for instance to provide it to another person who may for instance be in or near to the passageway 13. The sensors 6 may serve to detect objects that are lying on the floor. References 7 and 9 relate to laser beams directed along the door-wings 19 for detection of objects that are placed against said door-wings.

The part indicated with reference numeral 8 has as a primary function (see above) the scraping off of objects sticking to extremities of the door-wings 19, 19′, 19″ passing closely adjacent to a shell-wall 17. When it is embodied as a sensor, it also applies to the detection of such an object that sticks to the extremity of a door-wing passing closely adjacent the shell-wall 17 of revolving door 15.

From the above description, it will be apparent to any person skilled in the art that within the scope of the invention as embodied in the appended claims many variations are feasible without departing from said claims' protective scope.

What is claimed:

1. Revolving door lock having outer walls defining in-between said walls a passageway, comprising at the extremities of the passageway a first revolving door and a second revolving door that embody an entrance and an exit of the door lock, wherein each of the first revolving door and the second revolving door is provided with shell-walls shaped as parts of a cylinder-wall and wherein the revolving doors each have door-wings that are rotatable between said shell-walls such that during rotation extremities of said door-wings are movable adjacent to said shell-walls, wherein each of the first revolving door and the second revolving door is provided with at least three wings.

2. Revolving door lock according to claim 1, wherein the shell-walls are arranged such that when a wing of a revolving door is positioned perpendicular to an imaginary line through the axes of rotation of the door-wings, another wing is having its extremity positioned immediately adjacent to a shell-wall so as to effect that said revolving door is closed against draught.

3. Revolving door lock according to claim 1, wherein it comprises control means that control the rotation or interruption and/or blocking of rotation of at least one of the revolving doors, which control means are receivingly connected with detection means for detecting unauthorized situations.

4. Revolving door lock according to claim 1, wherein the passageway is provided with means for recognition of a person's movement-direction.

5. Revolving door lock according to claim 4, wherein the control means is arranged to interrupt and/or block rotation or to reverse rotation of the revolving door at the entrance when said means detects an unauthorized movement-direction.

6. Revolving door lock according to claim 4, wherein the said means are radar-transceivers positioned at the extremities of the passage-way.

7. Revolving door lock according to claim 1, wherein the passageway is placed off-centre with respect to an imaginary line through the axes of rotation of the door-wings so as to cause that passers-by can pass the door lock without noticeably moving sideways.

8. Revolving door lock according to claim 1, wherein the first revolving door and/or the second revolving door is equipped with means for object-detection selected from the group comprising object-sensors and a pressure-sensitive floor-part.

9. Revolving door lock according to claim 8, wherein the pressure-sensitive floor-part is provided in a predefined no-go area of the respective revolving doors, which no-go area is established in the path of passers-by going through the door-lock from the exit to the entrance.

10. Revolving door lock according to claim 8, wherein a control means is arranged to interrupt and/or block rotation or to reverse rotation of at least the revolving door of which the pressure-sensitive floor-part registers a load.

11. Revolving door lock according to claim 3, wherein the detection means for detecting unauthorized situations comprise one or more sensors for detecting objects in the revolving door at the entrance and/or the exit, and the control means is arranged to interrupt and/or to block rotation or reverse rotation of said revolving door upon activation of at least one of said sensors.

12. Revolving door lock according to claim 1, wherein it is provided with means on the shell-walls for scraping of objects sticking to extremities of the door-wings.
